(19) United States
(12) Patent Application Publication
(10) Pub. No.: US 2004/0122655 A1
(43) Pub. Date: Jun. 24, 2004

(54) Natural language input apparatus and storage medium which stores natural input program therein

(75) Inventor: Tomoe Yamakawa, Iwatsuki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/388,751

(22) Filed: Mar. 17, 2003

(30) Foreign Application Priority Data
Dec. 19, 2002 (JP) 2002-368413

(51) Int. Cl. G06F 17/28

(52) U.S. Cl. 704/4

(57) ABSTRACT

A clause extraction unit extracts not only a clause but also a word from an inputted natural sentence. A thesaurus converts words into a synonym to integrate the words. A term dictionary converts the word into a term corresponding to a printer function. A parameter conversion unit converts the term obtained by the term dictionary into a parameter. A drawing command process unit performs a drawing process on the basis of the parameter to transmit a drawing process result to a printer.

### BACKGROUND OF THE INVENTION

1. Field of the Invention

The present invention relates to a natural language input apparatus and a storage medium which stores a natural language input program therein, for example, a natural language input apparatus for setting the function of a device such as a printer or a facsimile device and a storage medium which stores a natural language input program therein.

2. Description of the Related Art

When a so-called host PC transmits data to a printer through a printer driver when data formed by using application software is printed by the printer.

In this case, the printer drive displays a UI (user interface) for setting a printer function before the data is transmitted to the printer. At this time, a user sets a function parameter by using the printer driver of the UI to obtain a desired output result. The printer driver converts the data into data described in a printer language by using the set parameter to transmit the data described in the printer language to the printer.

With advance of high-functional printer, the number of parameters to be set increases. Accordingly, a printer driver must display a very large number of UIs to set the parameters. The UIs may be displayed on a plurality of pages, so that the UIs cannot be viewed at a glance.

In addition, the printer driver displays UIs having functions which are not necessary for a certain user because the printer driver displays all settable functions by UIs. Therefore, it is the user to cumbersomely select and refuses necessary functions. In addition, an unskilled user very difficultly perform an operation for print setting to obtain a desired output form.

In order to avoid this, a technique for inputting predetermined information by using a natural language is desirably adopted to the printer driver.

Therefore, as the technique for inputting the natural language, a document searching device for automatically generating a searching condition from a searching request of document data input in the natural language is proposed (see Japanese Patent Application Laid-Open (JP-A) No. 8-33938).

According to the technique described in JP-A No. 8-339383, language analysis is performed to input natural language to extract independent words and ancillary words. The ancillary words are converted into predetermined operators for the respective ancillary words, and the corresponding independent words are combined to the operators to generate searching conditions.

However, when the technique described in Patent Document 1 is installed in the printer driver, it is very inconvenient that a user must input a natural language by using predetermined words.

### SUMMARY OF THE INVENTION

The present invention has been proposed to solve the above problems and has as its object to apply a natural language input apparatus which can set a function of a device by inputting a natural language without any operation load and a storage medium in which a natural input program is stored.

A first aspect of the first invention provides natural language input apparatus including: word extraction unit for extracting a word from an inputted natural language; a word conversion unit for converting the word extracted by the word extraction unit into a word corresponding to a function of a device to be set; parameter conversion unit for referring to a corresponding table of words and parameters and converting the word converted by the word conversion unit into a parameter; and setting unit for setting a function of the device on the basis of the parameter converted by the parameter conversion unit.

A first aspect of the second invention provides a natural language input program stored in a storage medium causing a computer to function as: word extraction unit for extracting a word from an inputted natural language; a word conversion unit for converting the word extracted by the word extraction unit into a word corresponding to a function of a device to be set; parameter conversion unit for referring to a corresponding table of words and parameters and converting the word converted by the word conversion unit into a parameter; and setting unit for setting a function of the device on the basis of the parameter converted by the parameter conversion unit.

The word extraction unit extract a word from an inputted natural language. The natural language mentioned here is not only sentences but also a string of at least one word. Therefore, when a word is input, the word is directly extracted.

The word conversion unit converts an extracted word into a word corresponding to a function of a device to be set. The above-mentioned word depending on the device to be set is a word related to a printer function when the device is, e.g., a printer.

The parameter conversion unit has a corresponding table expressing a relationship between words and parameters. The parameters mean parameters for setting the function of the device. The parameter conversion unit converts a word converted by the word conversion unit into a parameter on the basis of the corresponding table.

The setting unit sets a function of the device on the basis of the parameter converted by the parameter conversion unit.

Therefore, according to a first aspect of the first invention and a first aspect of the second invention, a word is extracted by an inputted natural language to obtain a parameter from the extracted word, and the setting of the function of the device is performed on the basis of the parameter, so that the function of the device can be automatically set on the basis of the natural language input by a user.

A second aspect of the first invention provides a natural language input apparatus according to the first aspect, wherein the word extraction unit extracts a word from any one of a sentence, words, and a plurality of words in random order as the natural language.

A second aspect of the second invention provides a natural language input program stored in the storage medium according to the first aspect of the invention, wherein the word extraction unit extracts a word from any one of a sentence, a word, and a plurality of words in random order as the natural language.

Therefore, according to the second and third aspects, even though any one of a sentence, a word, and a plurality of words in random order is input, the function of the device can be automatically set.

A third aspect of the first invention provides a natural language input apparatus according to the first or second aspects of the invention, the parameter conversion unit converts the word into a preset parameter when the corresponding table does not include the word converted by the word conversion unit.

A third aspect of the second invention provides a natural language input program stored in the storage medium according to the first and second aspect of the invention, wherein the parameter conversion unit converts the word into a preset parameter when the corresponding table does not include the word converted by the word conversion unit.

Therefore, according to the third aspects of the first invention and second aspect of the first invention, even though a user inputs an erroneous natural sentence, a setting error can be avoided.

A fourth aspect to the first invention provides a natural language input apparatus according to the any one of the first to third aspects further including a parameter changing unit for changing the parameter depending on the function of the device when the parameter set by the parameter conversion unit does not correspond to the function of the device, wherein the setting unit sets a function of the device on the basis of the parameter changed by the parameter changing unit.

A fourth aspect of the second invention provides a natural language input program stored in the storage medium according to any one of the first to third aspects of the invention further causing the computer to function as: a parameter changing unit for changing the parameter depending on the function of the device when the parameter set by the parameter conversion unit does not correspond to the function of the device, wherein the setting unit sets the function of the device on the basis of the parameter changed by the parameter changing unit.

Therefore, according to the fourth aspect of the first invention and the fourth aspect of the second invention, when the set parameter does not correspond to the function of the device, the parameter is changed depending on the function of the device, so that a setting error can be avoided even though a user inputs an erroneous natural sentence.

A fifth aspect of the second invention provides a natural language input apparatus according to the fourth aspect of the invention further including first notification unit for notifying of parameter change contents obtained by the parameter changing unit.

A fifth aspect of the second invention provides a natural language input program stored in the storage medium according to the tenth aspect further causing the computer to function as first notifying unit for notifying of parameter change contents obtained by the parameter changing unit.

The first notifying unit is not limited to a specific notifying unit when the notifying unit can perform notification by exciting the senses of a human being. For example, an image, voice, or the like may be output.

Therefore, according to the fifth aspect of the first invention and the fifth aspect of the second invention, when a user inputs an erroneous natural sentence, the user is notified that the erroneous natural sentence is input, so that the user herself/himself can recognize her/his erroneous input.

A sixth aspect of the first invention provides a natural language input apparatus according to any one of the first to fifth aspects further including second notification unit for notifying of setting contents obtained by the setting unit.

A sixth aspect of the second invention provides a natural language input program stored in the storage medium according to any one of the seventh to eleventh aspects further causing the computer to further function as second notification unit for notifying of setting contents obtained by the setting unit.

The second notification unit is not limited to a specific notification unit when the notifying unit can perform notification by exciting the senses of a human being. For example, an image, voice, or the like may be output.

Therefore, according to the sixth aspect of the first invention and sixth aspect of the second invention, a user herself/himself can recognize the contents set by inputting a natural sentence.

A third aspect of the invention provides a natural language input method including: the step of extracting a word from an inputted natural language; the step of converting the extracted word into a word corresponding to a device to be set; the step of referring to a corresponding table of words and parameters and converting the converted word into a parameter; and the step of setting a function of the device on the basis of the converted parameter.

### BRIEF DESCRIPTION OF THE DRAWINGS

FIG. 1 is a block diagram showing the configuration of a natural language input apparatus according to an embodiment of the present invention.

FIG. 2 is a diagram showing a driver setting screen displayed on a monitor.

FIG. 3 is a flow char showing the procedure of an operation device.

FIG. 4 is a diagram showing a parameter conversion table for setting the value of Devmode parameter.

FIG. 5 is a diagram showing a non-corresponding message screen displayed on the monitor.

FIG. 6 is a diagram showing a setting check screen displayed on the monitor.

### DESCRIPTION OF THE PREFERRED EMBODIMENTS

Preferred embodiments of the present invention will be described below with reference to the accompanying drawings.

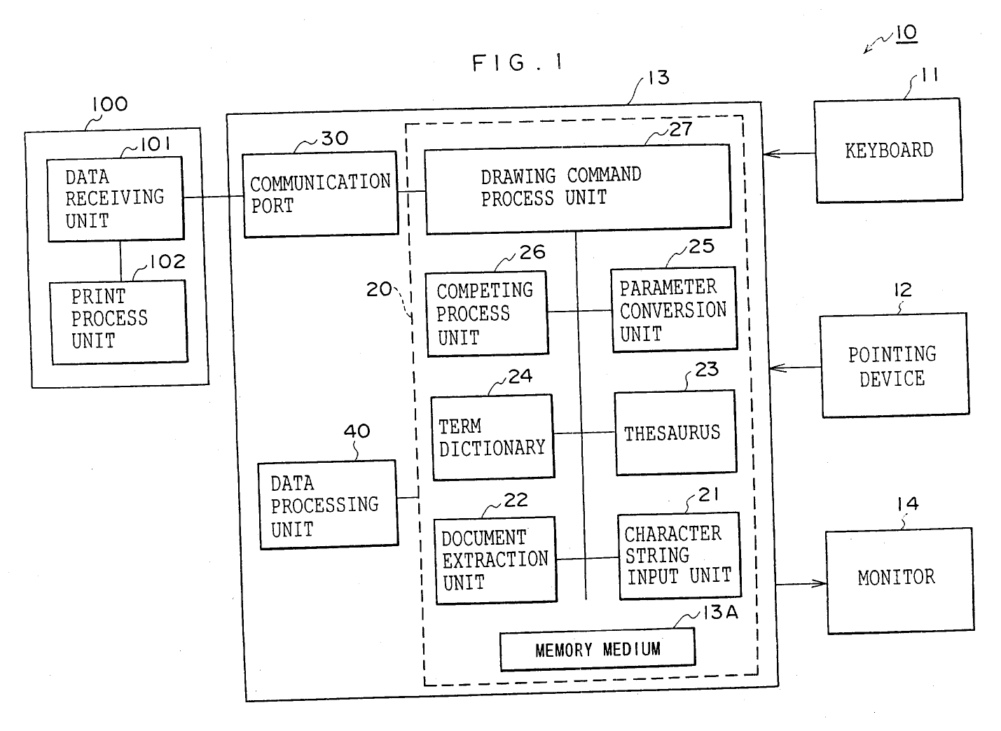

FIG. 1 is a block diagram showing the configuration of a natural language input apparatus 10 according to an embodiment of the invention.

The natural language input apparatus 10 is obtained by installing an operation system (OS) and an application program in a so-called personal computer. The natural language input apparatus 10 sets various functions of the printer 100.

The natural language input apparatus 10 comprises a keyboard 11 for inputting a natural language, a pointing device 12 which is a so-called mouse, an operation device 13 for performing a predetermined operation process, and a monitor 14 for displaying an operation result of the operation device 13.

On the other hand, the printer 100 comprises a data receiving unit 101 for receiving data transmitted from the natural language input apparatus 10 and a print process unit 102 for executing a print process of the data received by the data receiving unit 101.

The operation device 13 of the natural language input apparatus 10 comprises a printer function setting unit 20 for setting the various functions of the printer 100, a communication port 30 for transmitting/receiving data to/from the printer 100, and a data processing unit 40 for executing a predetermined data processing according to the application program. The printer function setting unit 20 is a so-called printer driver. The communication port 30 transmits the data processed by the data processing unit 40 to the printer 100 depending on the setting contents of the printer function setting unit 20.

The printer function setting unit 20 comprises a character string input unit 21 which receives a character string in a natural language, a clause extraction unit 22 for extracting a clause in the natural language input to the character string input unit 21, a thesaurus 23 in which synonyms of respective words are stored, a term dictionary 24 in which terms related to the printer functions are stored, a parameter conversion unit 25 for converting a term into a parameter, a competing process unit 26 for checking whether parameters compete with each other or not, and a drawing command process unit 27 for generating drawing data.

The operation device 13 constituted as described above starts the printer function setting unit 20 in response to a print instruction from the keyboard 11 or the pointing device 12, and displays a driver setting scene on the monitor 14.

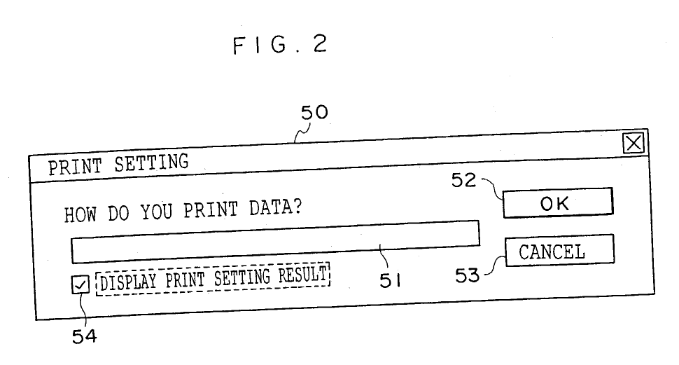

FIG. 2 is a diagram showing a driver setting screen 50 displayed on the monitor 14. The driver setting screen 50 displays an character string input box 51, an OK button 52, a cancel button 53, and a print setting result check box 54.

The character string input box 51 is a box for inputting a natural language which expresses contents for setting printer functions. The OK button 52 is a button for designating a setting of a printer function according to the natural language input to the character string input box 51. The cancel button 53 is a button for designating that the operation returns to the first previous process. The print setting result check box 54 designates whether a print setting result based on the natural language input to the character string input box 51 is displayed or not. When the print setting result check box 54 is checked, the print setting result is displayed. The print setting result check box 54 may be omitted.

A plurality words (one or more words) in random order may be input to the character string input box 51. For example, when monochromatic printing is executed, only words “white and black” may be input. In addition, high-resolution printing is performed in an original size, words may be segmented by spaces as a general rule to obtain “equal-magnification high-quality”.

When the operation device 13 detects that the OK button 52 is clicked, the operation device 13 supplies the natural language input to the character string input box 51 to the character string input unit 21 to execute the following processes.

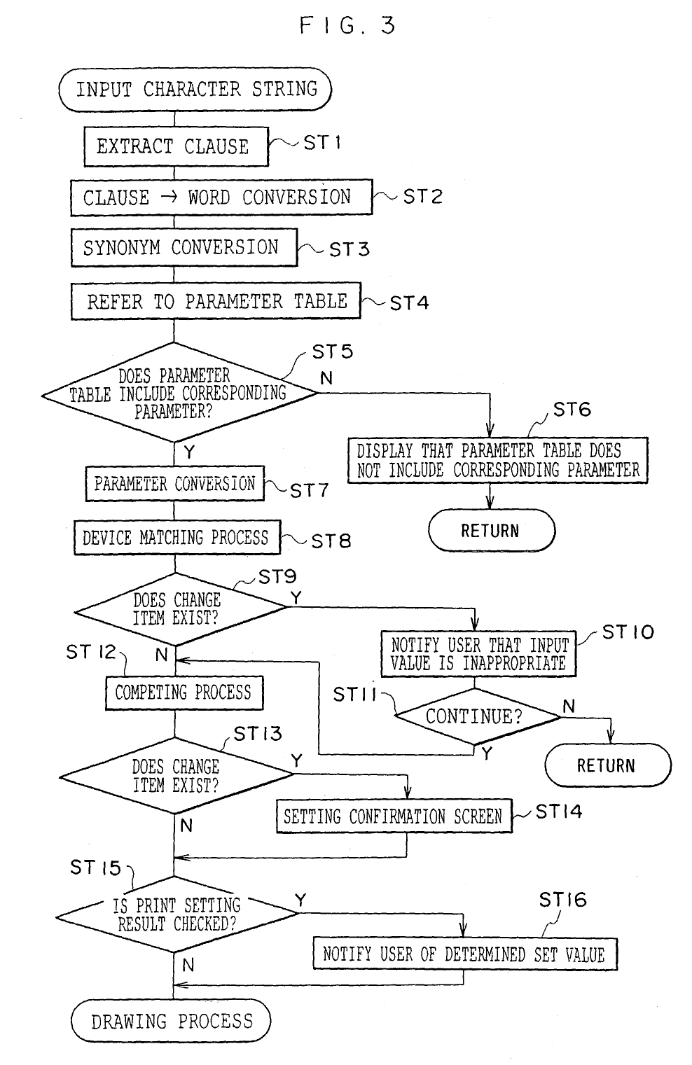

FIG. 3 is a flow chart (flow chart showing a natural language input program) showing the procedure of the operation device 13. The natural language input program is stored in a storage medium 13A arranged in the operation device 13. More specifically, when the operation device 13 detects that the OK button 52 is clicked, the operation device 13 reads the natural language input program stored in the storage medium 13A and executes the following processes through the units 22 to 27.

The clause extraction unit 22 extracts a clause from a character string input to the character string input unit 21 (step ST1). The clause extraction unit 22 classifies extracted clauses into words and connectives to convert the clauses into words (step ST2). The clause extraction unit 22 integrates a connective included in a nominative clause with a verb following the connective and changes the verb into present tense form. The other connectives are omitted.

For example, when a natural language “print a full black-and-white image”, the clause extraction unit 22 extracts five clauses “print/a/full/black-and-white/image”. The clause extraction unit 22 recognizes a space as a clause segmentation with respect to the two words “equal-magnification high-quality” segmented by the space to obtain words “equal-magnification” and “high-quality”.

The thesaurus 23 converts the respective words obtained by the clause extraction unit 22 into predetermined synonyms (step ST3). More specifically, words having similar meanings are collected as one set. For example, even though any one of words “black-and-white”, “monochrome”, and “black” is obtained by the clause extraction unit 22, the thesaurus 23 integrates these words as a word “Monochrome” to obtain an integrated word.

The term dictionary 24 converts the word obtained by the clause extraction unit 22 or the thesaurus 23 into a word which is specialized for a printer, i.e., a term related to a printer function. For example, clauses “full image”, “original size”, “automatic enlargement”, and “automatic reduction” are integrated as a clause “Auto Scale” to integrate words as terms related to a printer function.

The term dictionary 24 targets only terms related to “setting” of the printer functions, terms which are not targeted are omitted (erased). The words, e.g., “printing”, “print”, “do print”, “print out”, and “output” which are related to processes are related to “process” and are not terms related to the “setting” of the printer functions. For this reason, these terms are omitted. As a result, the term dictionary 24 extracts only unique terms related to the setting of the printer functions.

For example, the five clauses “print/a/full/black-and-white/image” extracted by the clause extraction unit 22 are converted into “Monochrome”, “Duplex”, and “Auto Scale” by the thesaurus 23 and the term dictionary 24.

The parameter conversion unit 25 stores a parameter conversion table for converting a term into a parameter.

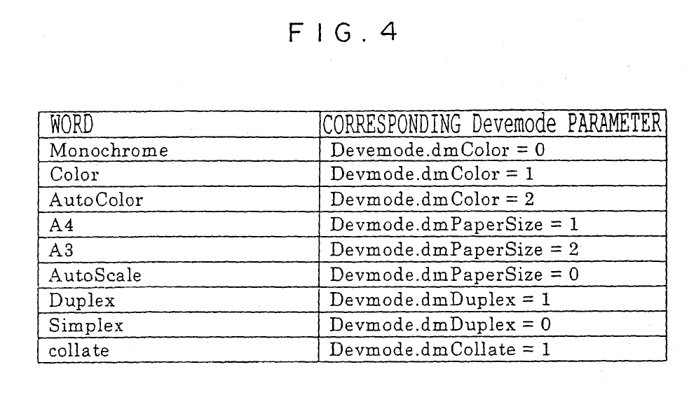

FIG. 4 is a diagram showing a parameter conversion table for setting the value of a Devmode parameter. This parameter conversion table expresses that “word” in the left column is converted into “corresponding Devmode parameter” in the right column. For example, “Color” is converted into “Devmode. dmColor=1” by the parameter conversion unit 25.

The parameter conversion unit 25 refers to the parameter conversation table (step ST4) to check whether the parameter conversion table includes a parameter corresponding to the term obtained by the term dictionary 24 or not (step ST4). In this embodiment, since printer functions are set, the parameter conversion unit 25 checks whether the parameter conversion table includes a Devmode parameter as a corresponding parameter or not.

When the parameter conversion table does not include the corresponding Devmode parameter, a screen expressing that the corresponding parameter does not exist is displayed on the screen of the monitor 14 (step ST6).

On the other hand, when the corresponding Devmode parameter exist, the parameter conversion unit 25 converts the term obtained by the term dictionary 24 into a parameter according to the parameter conversion table (step ST7). In addition, for setting a Devmode value, the parameter conversion unit 25 regards the Devmode value which does not correspond to a parameter converted from an input character string as a value which is not desired by a user to set a default value. These values are corrected by the next competing process unit 26 not to compete with the input value.

The competing process unit 26 executes a matching process for devices (step ST8). In this case, the competing process unit 26 checks whether the Devmode parameter obtained by the parameter conversion unit 25 corresponds to the printer 100 serving as an output device or not. When the printer 100 does not correspond to the Devmode parameter, the Devmode parameter value must be changed.

For example, although the printer 100 cannot perform double-sided printing, when the parameter is “Devmode. dmDuplex=1” (double-sided printing), the parameter must be changed. The competing process unit 26 checks whether the Devmode parameter includes an item to be changed or not (step ST9).

When the Devmode parameter includes the item to be changed, a non-corresponding message screen for notifying that the input value is inappropriate is displayed on the monitor 14 (step ST10).

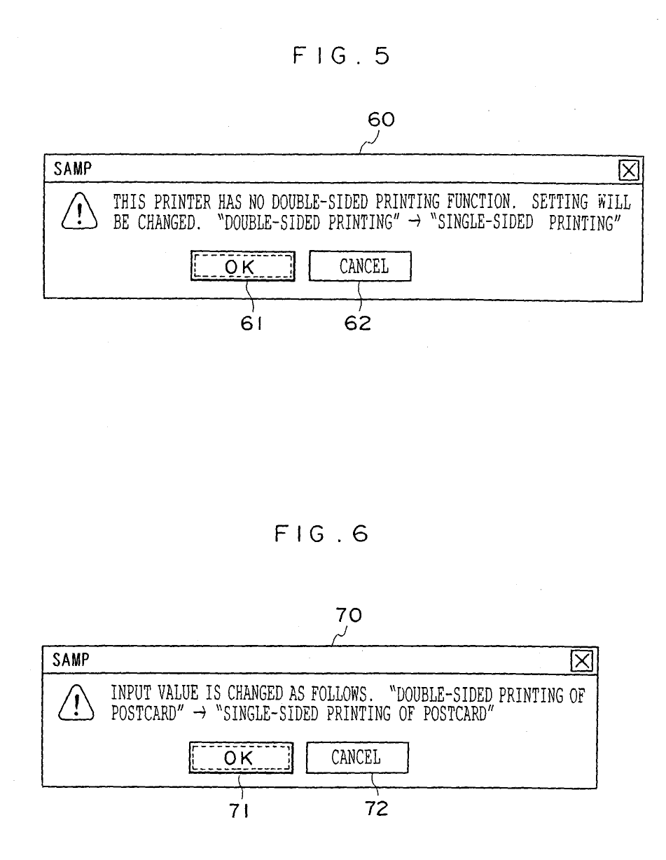

FIG. 5 is a diagram showing a non-corresponding message screen 60 displayed on a monitor 30. The non-corresponding message screen 60 displays an OK button 61 representing that a setting change is understood and a cancel button 62 representing a setting change is not performed.

The competing process unit 26 decides whether a printer function setting process is continued or not (step ST11). When the OK button 61 of the non-corresponding message screen 60 is clicked, the competing process unit 26 changes the parameter into a parameter which can correspond to the printer 100 to continue the printer function setting process, and the competing process unit 26 starts the next process (step ST12) For example, although the printer 100 cannot perform double-sided printing, when the parameter is set to be a parameter representing “double-sided printing”, the parameter is changed into a parameter representing “single-sided printing”. When the cancel button 62 is clicked, the competing process unit 26 returns to the process of step ST1.

The competing process unit 26 executes a decision process for checking whether the parameter obtained by the parameter conversion unit 25 and the parameter changed through step ST11 compete with each other or not (step ST12). The competing process unit 26 decides whether a parameter (change item) must be changed due to the competition or not (step ST13).

When the parameters include a change item, the competing process unit 26 changes a parameter having a low priority, and a setting confirmation screen 70 is displayed on the monitor 14 (step ST14).

FIG. 6 is a diagram showing the setting confirmation screen 70 displayed on the monitor 30. The setting confirmation screen 70 displays an OK button 71 representing setting confirmation and a cancel button 72 representing that a setting is not changed. When the OK button 71 is clicked, the process in the next step ST15 is started. On the other hand, when the cancel button 72 is clicked, the competing process unit 26 returns.

The printer 100 has only the function of “single-sided printing of postcard”. In contrast to this, a case in which a parameter representing “double-sided printing of postcard” is input to the natural language input apparatus 10 will be described below.

The parameter conversion unit 25 generates the following parameter representing “double-sided printing of postcard”.

Devmode. dmPapaerType=8 (8 unit “postcard”)

Devmode. dmDuplex=1 (unit both-sided printing)

The competing process unit 26 changes a parameter having a low priority to avoid competition because the two parameters compete with each other.

In this case, since

(Devmode. dmPaperType=8)∩(Devmode. dmDuplex=1) is satisfied (since the priority of both-sided printing is low), the parameter is changed into

Devmode. dmDuplex=0 (single-sided printing).

The competing process unit 26 checks whether the print setting result check box 54 of the driver setting screen 50 shown in FIG. 2 is checked or not (step ST15).

When the print setting result check box 54 is checked, a print setting result screen is displayed on the monitor 14 (step ST16). Thereafter, the competing process unit 26 starts the drawing process. On the other hand, when the print setting result check box 54 is not checked, the competing process unit 26 directly starts the drawing process.

The drawing command process unit 27 performs the drawing process on the basis of a parameter obtained through the processes in steps ST1 to ST 16. Drawing data obtained as a result is supplied to the communication port 30. The communication port 30 transmits the drawing data to the data receiving unit 101 of the printer 100.

On the other hand, the process unit 102 of the printer 100 executes a print-out operation on the basis of the drawing command received by the data receiving unit 101.

As described above, since the natural language input apparatus 10 according to the embodiment of the invention can set various functions of the printer 100 on the basis of a natural language input by a user, load on the operation of the user can be considerably reduced. More specifically, the user sets the printer 100 as if the user asks an operator to set the functions by her/his utterance.

Since the natural language input apparatus 10 can set the various functions without displaying UIs corresponding to the functions depending on the printer 100, UIs which are shared by different devices can be provided.

In addition, even though a function desired by a user is set, when the function is not a function to be set, the natural language input apparatus 10 can automatically perform the desired setting. For this reason, a data generation error caused by an input error of a user can be avoided.

The invention is not limited to the embodiment described above, and the invention can be variously changed in design without departing from the spirit and scope of the invention. For example, in the embodiment, the printer 100 serving as a device to be set by the natural language input apparatus 10 has been exemplified. However, another device may be used. At this time, the term dictionary 24 and the parameter conversion unit 25 corresponding to the device may be used.

In the embodiment, as a unit for inputting a natural language, the keyboard 11 has been exemplified. However, the unit is not limited to the keyboard 11. For example, an input microphone and a voice recognition process unit are arranged in the natural language input apparatus 10, so that voice may be converted into a natural language.

In addition, the natural language input apparatus 10 may be linked with the server. In this manner, an optimum device which satisfies an input condition can be automatically selected from a plurality of devices of different types, and a system for transmitting predetermined data can be structured.

As the storage medium 13A arranged in the operation device 13 in which the natural language input program is stored, a hard disk, a CD-ROM, a flexible disk, and the like can be used. Therefore, the program can be dealt through these storage media. The program can also be dealt through a communication unit, e.g., the internet. Therefore, in this case, the communication medium which communicates with the program, e.g., a predetermined signal or a carrier wave corresponds to a storage medium.

What is claimed is:

1. A natural language input apparatus comprising:
word extrac01tion unit for extracting a word from an inputted natural language;
word conversion unit for converting the word extracted by the word extraction unit into a word corresponding to a function of a device to be set;
parameter conversion unit for referring to a corresponding table of words and parameters converting the word converted by the word conversion unit into a parameter; and
setting unit for setting a function of the device on the basis of the parameter converted by the parameter conversion unit.

2. A natural language input apparatus according to claim 1, wherein
the word extraction unit extracts a word from any one of a sentence, words, and a plurality of words in random order as the natural language.

3. A natural language input apparatus according to claim 1, wherein
the parameter conversion unit converts the word into a preset parameter when the corresponding table does not include the word converted by the word conversion unit.

4. A natural language input apparatus according to claim 1 further comprising:
parameter changing unit for changing the parameter depending on the function of the device when the parameter set by the parameter conversion unit does not correspond to the function of the device,
wherein the setting unit sets a function of the device on the basis of the parameter changed by the parameter changing unit.

5. A natural language input apparatus according to claim 4 further comprising:
first notification unit for notifying of parameter change contents obtained by the parameter changing unit.

6. A natural language input apparatus according to claim 1 further comprising:
second notification unit for notifying of setting contents obtained by the setting unit.

7. A storage medium which stores an natural language input program for causing a computer to function as:
word extraction unit for extracting a word from an inputted natural language;
word conversion unit for converting the word extracted by the word extraction unit into a word corresponding to a function of a device to be set;
parameter conversion unit for referring to a corresponding table of words and parameters and converting the word converted by the word conversion unit into a parameter; and
setting unit for setting a function of the device on the basis of the parameter converted by the parameter conversion unit.

8. A storage medium, which stores a natural language input program according to claim 7, wherein
the word extraction unit extracts a word from any one of a sentence, words, and a plurality of words in random order as the natural language.

9. A storage medium, which stores a natural language input program according to claim 7, wherein
the parameter conversion unit converts the word into a preset parameter when the corresponding table does not include the word converted by the word conversion unit.

10. A storage unit, which stores a natural language input program according to claim 7, further making the computer function as:
parameter changing unit for changing the parameter depending on the function of the device when the parameter set by the parameter conversion unit does not correspond to the function of the device,
wherein the setting unit sets a function of the device on the basis of the parameter changed by the parameter changing unit.

11. A storage medium which stores a natural language input program according to claim 10, further causing the computer to function as:
first notification unit for notifying of parameter change contents obtained by the parameter changing unit.

12. A storage medium which stores a natural language input program according to claim 7, further causing the computer to function as:
second notification unit for notifying of setting contents obtained by the setting unit.

13. A natural language input method comprising steps of:
extracting a word from an inputted natural language;
converting the extracted word into a word corresponding to a device to be set;
referring to a corresponding table of words and parameters and converting the converted word into a parameter; and
setting a function of the device on the basis of the converted parameter.
